(19) United States
(12) Patent Application Publication
(10) Pub. No.: US 2007/0064696 A1
(43) Pub. Date: Mar. 22, 2007

(54) Method for automatically setting network

(76) Inventor: Ku-Bong Min, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 10/575,410

(22) PCT Filed: Sep. 16, 2004
(86) PCT No.: PCT/KR04/02368

§ 371 Date: Apr. 7, 2006

(30) Foreign Application Priority Data
Oct. 11, 2003 (KR) 10-2003-0070869

(51) Int. Cl. H04L 12/56

(52) U.S. Cl. 370/392

(57) ABSTRACT

Disclosed is a method for automatically setting a network so that UPnP devices connected to a network composed of different IP segments can be communicated one another. The method comprises: receiving an event message transmitted from a device connected to a network; requesting a routing table to all devices connected to the network except said device; and adding an IP address of said device to the routing tables inside all the devices.

### TECHNICAL FIELD

The present invention relates to a network, and more particularly to, a method for automatically setting a network.

### BACKGROUND ART

With popularization of a ultrahigh speed internet and digitalization of electric products, there have been attempts to connect a personal computer (PC), a network gateway device, an audio/video device, home appliances and a control device through one home network.

A network environment based on the PC in houses has been gradually changed into an environment using various sub network technologies due to the diffusion of home networking. A universal plug and play (UPnP) technology has been suggested due to necessity of independently uniformly networking the electric products by using an IP protocol.

The UPnP, which is defined by a protocol of the standard network architecture, is one of the major standard technologies of the home network which a plurality of companies in each country create through the UPnP forum. A UPnP-based home network system includes a plurality of UPnP devices for providing services, and a control point for controlling the plurality of UPnP devices.

The control point means a controller having functions of sensing and controlling various UPnP devices. That is, the control point is a controller for controlling various devices (for example, UPnP devices). By the key input of the user, the control point discovers various UPnP devices, obtains description information of the discovered UPnP devices, and controls the UPnP devices.

Exemplary UPnP devices include devices connected to the home network, such as a PC, a network equipment, a peripheral device such as a printer, an audio/video device and home appliances. The UPnP devices notify their events to the control point.

The control point discovers the UPnP devices by IP multicast. That is, when the UPnP device is added to the network, the control point multicasts an alive message of a simple service discovery protocol (SSDP) to the network through a new IP. Here, the control point can wait for the response from the UPnP device after multicasting the SSDP M-search message.

On the other hand, when the home network is constructed, if a host or devices are connected to heterogeneous physical networks, the host or the devices probably need to be provided with IP addresses, respectively. That is, the home network may be comprised of two or more IP segments.

In order to construct the UPnP-based home network, the home network must use an IP as a network protocol, and the IP multicast must be performed in the home network.

Currently, most of the gateways do not support the IP multicast. Generally, the UPnP-based home network is constructed in the physical networks connected by bridging. That is, one IP segment becomes a UPnP-based home network area. Theoretically, when the IP multicast is supported, the UPnP-based home network can be constructed by connecting maximally four heterogeneous IP segments.

However, the network is not automatically set between the UPnP-devices in the home network environment consisting of heterogeneous IP segments. Accordingly, the UPnP devices connected to the home network cannot perform IP communication with each other.

### DISCLOSURE OF THE INVENTION

Therefore, an object of the present invention is to provide a method for automatically setting a network which allows UPnP devices connected to a network consisting of heterogeneous IP segments to perform IP communication with each other.

To achieve these and other advantages and in accordance with the purpose of the present invention, as embodied and broadly described herein, there is provided a method for automatically setting a network, including the steps of: receiving an event message from a device connected to a network; requesting routing tables to all devices connected to the network except for the device; and adding an IP address of the device to the routing tables of the devices.

According to another aspect of the present invention, a method for automatically setting a network includes the steps of: receiving an event message from a UPnP device connected to a UPnP-based network; requesting routing tables to all UPnP devices connected to the network except for the UPnP device; and adding an IP address of the UPnP device to the routing tables of the UPnP devices, so that the UPnP device can be operated as a gateway.

According to yet another aspect of the present invention, a method for automatically setting a network includes the steps of: receiving an event message from a UPnP device discovered among UPnP devices connected to a UPnP-based network system; requesting routing tables to all UPnP devices except for the discovered UPnP device; and when two or more IP addresses have been registered in IP address information of the event message, adding the IP address of the discovered UPnP device to the routing tables, so that the discovered UPnP device can be operated as a gateway. Preferably, the event message is an IP network management event message.

According to yet another aspect of the present invention, in a UPnP-based home network system having two or more UPnP devices and one or more control points, a method for automatically setting a network includes the steps of: receiving an event message from a discovered-UPnP device; when two or more IP addresses have been registered in IP address information of the event message, requesting routing tables to all UPnP devices except for the discovered UPnP device; and adding the IP address of the UPnP device to the routing tables.

According to yet another aspect of the present invention, a method for automatically setting a network includes the steps of: receiving an event message from any one of devices connected to a network consisting of heterogeneous IP segments; requesting routing tables to all devices connected to the network except for the device transmitting the event message; and adding an IP address of the device to the routing tables of the devices.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a structure view illustrating a local network consisting of two IP segments in order to explain a method for automatically setting a network in accordance with the present invention;

FIG. 2 is an exemplary view illustrating routing tables of each UPnP device connected to the network of FIG. 1;

FIG. 3 is a table showing state variables of an IPNM service applied to the method for automatically setting the network in accordance with the present invention;

FIG. 4 is an exemplary view illustrating a display form of ‘IPAddressList’ of the IPNM service applied to the method for automatically setting the network in accordance with the present invention;

FIG. 5 is a table showing actions of the IPNM service applied to the method for automatically setting the network in accordance with the present invention;

FIG. 6 is an exemplary view illustrating a display form of a routing table applied to the method for automatically setting the network in accordance with the present invention; and

FIG. 7 is a flowchart showing sequential steps of the method for automatically setting the network in accordance with the present invention.

### MODES FOR CARRYING OUT THE PREFERRED EMBODIMENTS

Reference will now be made in detail to the preferred embodiments of the present invention, examples of which are illustrated in the accompanying drawings.

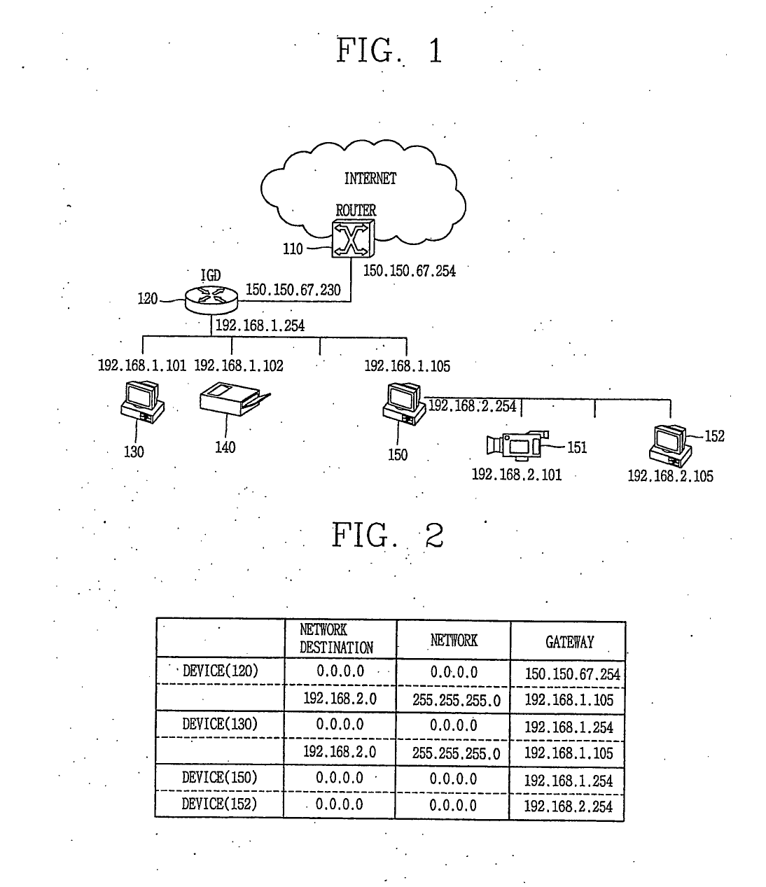

In a UPnP-based network system having two or more UPnP devices and one or more control points, a method for automatically setting a network including the steps of: receiving an event message from a discovered UPnP device; when two or more IP addresses have been registered in IP address information of the event message, confirming whether unicast and multicast forwarding functions are supported through the event message; when the unicast and multicast forwarding functions are supported, requesting routing tables to all UPnP devices except for the UPnP device transmitting the event message (evented device); and adding the IP address of the evented device to the routing tables will now be explained in detail with reference to FIGS. 1 to 7.

FIG. 1 is a structure view illustrating a local network consisting of two IP segments in order to explain the method for automatically setting the network in accordance with the present invention.

Referring to FIG. 1, the local network consisting of the two IP segments includes a first home network consisting of an internet gateway device (IGD) 120 connected to an internet router 110, PCs 130 and 150 connected to the IGD 120, and an IP network equipment 140, and a second home network consisting of an IP network equipment 151 connected to the PC 150, and a PC 152. Here, the second home network has a different IP address from an IP address given to the first home network.

The IGD 120 provides a service of translating a private IP of the local network into its IP by a network address translation (NAT) function.

The operation of the local network consisting of the two IP segments will now be explained with reference to the routing tables of the UPnP devices (for example, PC, IP network equipment, etc.) of FIG. 2.

FIG. 2 is an exemplary view illustrating the routing tables of each UPnP device connected to the network of FIG. 1.

The IGD 120 registers an IP address (for example, 150.150.67.254) of the internet router 110 as a default gateway, and also registers an IP address (for example, 192.168.1.105) of the PC 150 operated as the gateway to access 192.168.2.0 network.

The PC 130 registers an IP address (for example, 192.168.1.254) of the IGD 120 that is the IP segment, and also registers the IP address (for example, 192.168.1.105) of the PC 150 operated as the gateway to access the sub network (second home network) of the PC 150.

The PC 150 is located on the boundary between the IGD 120 and the sub network to directly access the first home network and the second home network. Therefore, the PC 150 registers an IP address (for example, 192.168.1.254) of the IGD 120.

The PC 150 provides a forwarding service of IP packets between the first home network and the second home network, and forwards multicast packets to discover the UPnP devices connected to the first and second home networks.

The PC 152 registers an IP address (for example, 192.168.2.254) of the PC 150, so that the PC 150 can be recognized as a default gateway.

There are presumed that the routing tables for the network of FIG. 1 are registered as shown in FIG. 2 and that the UPnP service is defined to automatically set the network as shown in FIG. 2. The defined UPnP service will now be described.

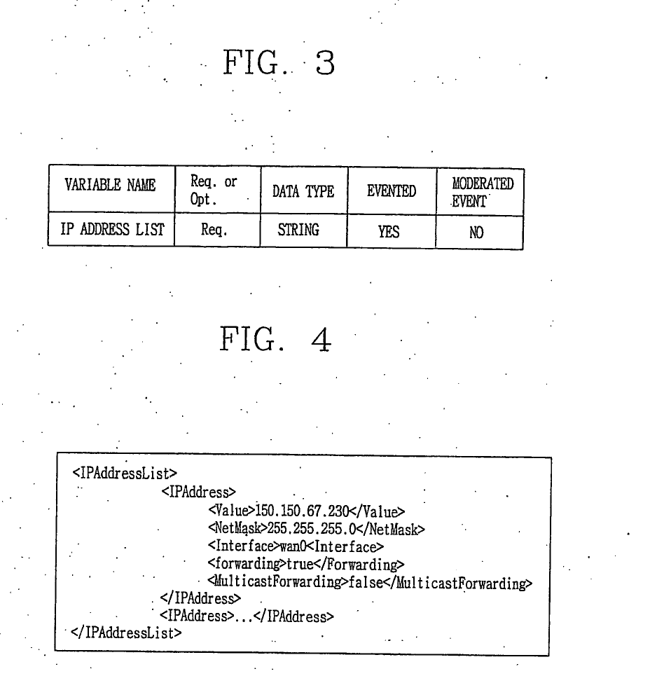

The UPnP service defined in this embodiment is designated as an IP network management (IPNM) service, and the UPnP device providing the IPNM service is designated as a UPnP IPNM device. As illustrated in FIG. 3, the IPNM service has ‘IPAddressList’ as a state variable.

The state variable is evented when the control point (for example, PC) discovering and controlling the UPnP IPNM device firstly joints an event service or whenever a new interface is added or an IP address is changed. Here, the state variable includes information on an interface of a host, an IP address, a network mask and forwarding capability.

The information can be represented as an extensible markup language (XML) document. The XML document can be escaped into strings and transmitted to the control point. For example, the XML of ‘IPAddressList’ that is the state variable can be represented as shown in FIG. 4. That is, ‘IPAddress’ state variable can be represented as a plurality of ‘IPAddress elements’. Each ‘IPAddress element’ includes information such as ‘Value’, ‘Netmask’, ‘Interface’, ‘Forwarding’ and ‘MulticastForwarding’.

‘Value’ represents an IP address of an interface of the UPnP IPNM device, ‘Netmask’ represents a network mask of the IP address of the interface of the UPnP IPNM device, ‘Interface’ represents a name of the interface of the UPnP IPNM device, ‘Forwarding’ represents whether the interface of the UPnP IPNM device provides an IP packet forwarding service, and ‘MulticastForwarding’ represents whether the UPnP IPNM device supports a multicast packet forwarding service.

Therefore, the control point (for example, PC) joining the IPNM service can search the interface information and forwarding capability of the UPnP IPNM device (for example, PC, IP network equipment, etc.).

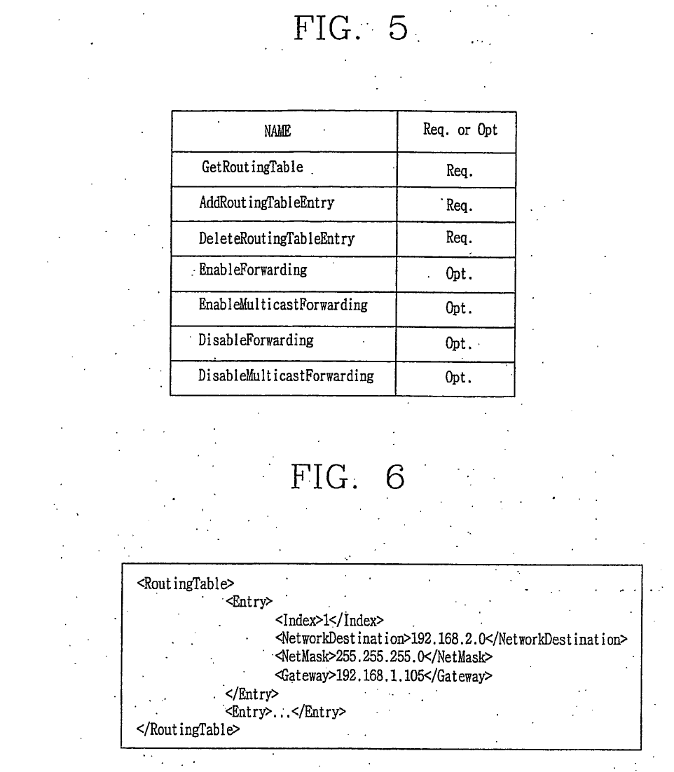

On the other hand, actions provided by the IPNM service can be defined as shown in FIG. 5. Definitions of each action will now. be explained.

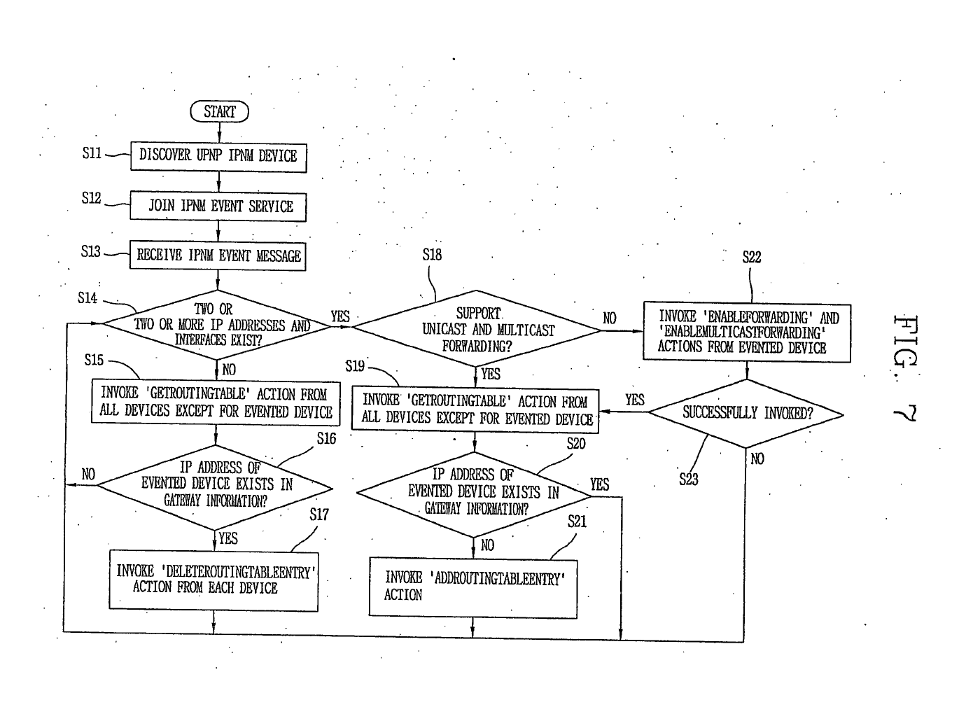

First, ‘GetRoutingTable’ action provides the routing table of UPnP IPNM device (for example, PC). As illustrated in FIG. 6, the routing table provided in response to the ‘GetRoutingTable’ action can be represented as an XML document, and the XML document can be escaped into strings and provided to the control point joining the IPNM service.

‘AddRoutingTableEntry’ action adds one routing table entry of the UPnP IPNM device (for example, PC). For example, an IP address of a network destination that is a routing table element, ‘NetworkMask’ and ‘Gateway’ are given as input arguments. The information provided in response to the ‘AddRoutingTableEntry’ action includes action success/fail and an index of the routing table entry.

‘DeleteRoutingTableEntry’ action deletes a specific routing table entry value. That is, the input argument is an index, and the information provided in response to the ‘DeleteRoutingTableEntry’ action is action success/fail.

‘EnableForwarding’ action enables a forwarding function for a specific interface of the UPnP IPNM device (for example, PC). Conversely, ‘DisableForwarding’ action disables a forwarding function for a specific interface of the UPnP IPNM device (for example, PC).

‘EnableMulticastForwarding’ action enables a forwarding function for a multicast packet in regard to a specific interface of the UPnP IPNM device (for example, PC). On the other hand, ‘DisableMulticastForwarding’ action disables a forwarding function for a multicast packet in regard to a specific interface of the UPnP IPNM device (for example; PC).

In accordance with the present invention, the routing table of the UPnP IPNM device can be represented as the XML. For example, as shown in FIG. 6, ‘RoutingTable’ element represents a routing table and includes ‘Entry’ as a sub element.

‘Entry’ includes ‘Index’, ‘NetworkDestination’, ‘NetMask’ and ‘Gateway’ as sub elements. ‘Index’ represents an index of a routing table entry, ‘NetworkDestination’ represents an address of a network destination, ‘NetMask’ represents a network mask, and ‘Gateway’ represents an address of a gateway.

The operation of the method for automatically setting the network by using the defined IPNM service in accordance with the present invention will now be described in detail with reference to FIG. 7.

FIG. 7 is a flowchart showing sequential steps of the method for automatically setting the network in accordance with the present invention. In the UPnP-based network system including two or more UPnP IPNM devices and one or more control points, the method for automatically setting the network will now be explained in detail.

The control point (for example, PC) of the UPnP-based network system discovers the UPnP IPNM service.

When discovering the UPnP IPNM device providing the UPnP IPNM service (S11), the control point joins an IPNM event service of the discovered UPnP IPNM device (S12).

The control point receives an event message (IPNM event message) from the discovered UPnP IPNM device (S13), and confirms whether two or more IP addresses exist in ‘IPAddressList’ information of the event message (S14). When two or more IP addresses exist in the ‘IPAddressList’ information, the control point confirms whether the interface of the evented UPnP IPNM device (UPnP IPNM device transmitting the IPNM event message) supports a unicast forwarding function and a multicast forwarding function (S18). Here, the evented UPnP IPNM device means the UPnP IPNM device transmitting the IPNM event message to the control point (for example, PC).

Therefore, when the interface of the evented UPnP IPNM device supports the unicast forwarding function and the multicast forwarding function, the control point (for example, PC) invokes ‘GetRoutingTable’ action from all UPnP IPNM devices registered in the UPnP-based network except for the evented UPnP IPNM device, thereby receiving the routing tables from the UPnP IPNM devices (S19).

On the other hand, when the interface of the evented UPnP IPNM device does not support the unicast forwarding function and the multicast forwarding function, the control point invokes the ‘EnableForwarding’ action and the ‘EnableMulticastForwarding’ action from the evented UPnP IPNM device (S22). Here, when the control points fails to invoke ‘EnableForwarding’ action and ‘EnableMulticastForwarding’ action, the control point returns to the above step and receives the event message again (S13).

When the control point succeeds in invoking the ‘EnableMulticastForwarding’ action, the control point invokes the GetRoutingTable’ action from all UPnP IPNM devices registered in the UPnP-based network except for the evented UPnP IPNM device, thereby receiving the routing tables from the UPnP IPNM devices (S19).

Thereafter, the control point confirms whether the IP address of the evented UPnP IPNM device has been registered in gateway information of the routing tables of the UPnP IPNM devices except for the evented UPnP IPNM device (S20). When the IP address of the evented UPnP IPNM device has already been registered in the gateway information of the routing tables, the control point receives the event message again. Here, when the IP address of the evented UPnP IPNM device has already been registered in the gateway information of the routing tables, the evented UPnP IPNM device is operated as a gateway.

When the IP address of the evented UPnP IPNM device has not been registered in the gateway information of the routing tables, the control point adds a routing table entry by invoking ‘AddRoutingTableEntry’ action, and receives the event message (S21). That is, when the IP address of the evented UPnP IPNM device has not been registered in the routing tables, the control point adds the IP address of the evented UPnP IPNM device to the routing tables, so that the UPnP IPNM device can be operated as a gateway.

Accordingly, the IP address of the UPnP IPNM device connected to the home network consisting of heterogeneous IP segments and discovered is automatically added to the routing tables of the UPnP IPNM devices except for the UPnP IPNM device, so that the UPnP IPNM devices connected to the home network consisting of heterogeneous IP segments can perform the IP communication with each other.

On the other hand, when the control point receives the event message in the above step (S13), if one IP address exists in the ‘IPAddressList’ information, the control point invokes the ‘GetRoutingTable’ action from all UPnP IPNM devices registered in the UPnP-based network except for the evented UPnP IPNM device, thereby receiving the routing tables from the UPnP IPNM devices (S15). Here, the control point confirms whether the IP address of the evented UPnP IPNM device exists in the gateway information of each routing table (S16).

When the IP address of the evented UPnP IPNM device exists in the gateway information, the evented UPnP IPNM device cannot be operated as a gateway. Therefore, the control point corrects the routing tables by deleting the IP address of the evented UPnP IPNM device stored in the routing tables by invoking ‘DeleteRoutingTable’ action in regard to the routing table entry including the gateway information (S17). When finishing correcting the routing tables, the control point receives the event message again. For example, when only one IP address of the evented UPnP IPNM device exists, it means that the evented UPnP IPNM device is connected to one network. Accordingly, the evented UPnP IPNM device cannot be operated as a gateway any more. In the case that one IP address has been registered in the IP address information of the event message from the evented UPnP IPNM device, the control point preferably deletes the IP address of the evented device added to the routing tables, so that the evented UPnP IPNM device can be connected to one home network and normally operated.

As a result, the routing tables and the forwarding parameters of each UPnP IPNM device are automatically set, so that the UPnP IPNM devices can perform the IP communication with each other.

On the other hand, an allowed control point can be set to control the UPnP IPNM devices connected to the network by using a UPnP security service. That is, the network can be reliably easily automatically set merely by using the UPnP protocol. In addition, the method for automatically setting the network can be applied to general networks as well as the UPnP-based network.

As discussed earlier, in accordance with the present invention, the network can be automatically set between the devices in the network environment consisting of heterogeneous IP segments. Accordingly, the devices can perform the UPnP-based IP communication with each other, which consults users' convenience.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method for automatically setting a network, comprising the steps of:
receiving an event message from a device connected to a network;
requesting routing tables to all devices connected to the network except for the device; and
adding an IP address of the device to the routing tables of the devices.

2. The method of claim 1, further comprising, when two or more IP addresses have been registered in IP address information of the event message, a step for confirming whether unicast and multicast forwarding functions are supported through the event message.

3. The method of claim 2, wherein, when the unicast and multicast forwarding functions are supported, the step for requesting the routing tables requests the routing tables to all devices except for the device transmitting the event message.

4. The method of claim 1, wherein, when two or more IP addresses have been registered in the IP address information of the event message, the step for adding the IP address of the device adds the IP address of the device to the routing tables.

5. The method of claim 1, wherein, when the IP address of the device has not been registered in the routing tables, the step for adding the IP address of the device adds the IP address of the device to the routing tables.

6. The method of claim 1, wherein the device and the devices are connected to a UPnP-based network consisting of heterogeneous IP segments.

7. The method of claim 1, wherein the event message is an IP network management event message.

8. The method of claim 1, further comprising, when one IP address has been registered in the IP address information of the event message from the device, a step for deleting the IP address of the device added to the routing tables.

9. A method for automatically setting a network, comprising the steps of:
receiving an event message from a UPnP device connected to a UPnP-based network;
requesting routing tables to all UPnP devices connected to the network except for the UPnP device; and
adding an IP address of the UPnP device to the routing tables of the UPnP devices, so that the UPnP device can be operated as a gateway.

10. The method of claim 9, wherein the event message is an IP network management event message.

11. A method for automatically setting, a network, comprising the steps of:
receiving an event message from a UPnP device discovered among UPnP devices connected to a UPnP-based network system;
requesting routing tables to all UPnP devices except for the discovered UPnP device; and
when two or more IP addresses have been registered in IP address information of the event message, adding the IP address of the discovered UPnP device to the routing tables, so that the discovered UPnP device can be operated as a gateway,
wherein the event message is an IP network management event message.

12. In a UPnP-based home network system having two or more UPnP devices and one or more control points, a method for automatically setting a network, comprising the steps of:
receiving an event message from a discovered UPnP device;
when two or more IP addresses have been registered in IP address information of the event message, requesting routing tables to all UPnP devices except for the discovered UPnP device; and
adding the IP address of the discovered UPnP device to the routing tables.

13. The method of claim 12, further comprising, when one IP address has been registered in IP address information of the event message, a step for requesting the routing tables to all UPnP devices except for the discovered UPnP device and deleting the IP address of the discovered UPnP device from the routing tables.

14. The method of claim 12, further comprising, when the IP address of the discovered UPnP device is added to the routing tables and the discovered UPnP device is operated as a gateway, a step for invoking unicast/multicast forwarding from the discovered UPnP device.

15. The method of claim 14, further comprising, when the unicast/multicast forwarding is not invoked, a step for receiving the event message again.

16. The method of claim 14, further comprising, when the discovered UPnP device is not operated as the gateway, a step for requesting the routing tables to all UPnP devices except for the UPnP device and deleting the IP address of the UPnP device from the routing tables.

17. The method of claim 12, wherein the IP address of the discovered UPnP device is added to or deleted from the routing tables, when the control point invokes UPnP service actions.

18. A method for automatically setting a network, comprising the steps of:
receiving an event message from any one of devices connected to a network consisting of heterogeneous IP segments;
requesting routing tables to all devices connected to the network except for the device transmitting the event message; and
adding an IP address of the device to the routing tables of the devices.

19. The method of claim 18, wherein the network is a UPnP-based network.

20. The method of claim 18, wherein the event message is an IP network management event message.
